(19) United States
(12) Patent Application Publication
(10) Pub. No.: US 2023/0152848 A1
(43) Pub. Date: May 18, 2023

(54) ELECTRONIC DEVICE

(71) Applicant: VIVO MOBILE COMMUNICATION CO., LTD, Dongguan (CN)

(72) Inventor: Shuitong YU, Dongguan (CN)

(73) Assignee: VIVO MOBILE COMMUNICATION CO., LTD, Dongguan (CN)

(21) Appl. No.: 18/150,846

(22) Filed: Jan. 6, 2023

Related U.S. Application Data
(63) Continuation of application No. PCT/CN21/04012, filed on Jul. 1, 2021.

(30) Foreign Application Priority Data
Jul. 7, 2020 (CN) 202010646345.X

(51) Int. Cl. G06F 1/16

(52) U.S. Cl. CPC G06F 1/1616; G06F 1/1688

(57) ABSTRACT

An electronic device includes a first main body, a second main body, a speaker module, and a connecting tube. the first main body is provided with a first cavity and a speaker module, and the first cavity is in communication with the speaker module; the second main body is provided with a second cavity; and the connecting tube is disposed at a rotational joint between the first main body and the second main body, two ends of the connecting tube are respectively in communication with the first cavity and the second cavity. The connecting tube is stretchable, in a case that the two main bodies rotate relative to each other to a folded state, the connecting tube is in a stretched state; and when the two main bodies rotate relative to each other to an unfolded state, the connecting tube is in a compressed state.

### CROSS-REFERENCE TO RELATED APPLICATIONS

This application is a Bypass Continuation application of PCT/CN2021/104012 filed on Jul. 1, 2021, which claims priority to Chinese Patent Application No. 202010646345.X filed on Jul. 7, 2020, which are incorporated herein by reference in their entirety.

### TECHNICAL FIELD

This disclosure relates to the field of communication device technologies, and specifically, to an electronic device.

### BACKGROUND

To obtain a better sound quality experience, a user has an increasingly high requirement on the sound quality of a speaker module of an electronic device. In a process of implementing this disclosure, the inventor finds that the existing technologies at least have the following problems: Existing electronic devices have limited space for the speaker module, which makes it difficult to improve an audio playback effect that the speaker module of the electronic device can achieve in the limited space, resulting in poor user experience.

### SUMMARY

Embodiments of this disclosure provide an electronic device.

According to a first aspect, an embodiment of this disclosure provides an electronic device, including: a first main body, a second main body, a speaker module, and a connecting tube, where

the first main body and the second main body are rotatable relative to each other to a folded state or an unfolded state;

the first main body is provided with a first cavity and the speaker module, and the first cavity is in communication with the speaker module;

the second main body is provided with a second cavity; and

the connecting tube is disposed at a rotational joint between the first main body and the second main body, two ends of the connecting tube are respectively in communication with the first cavity and the second cavity, the first cavity, the connecting tube, and the second cavity together form a rear sound cavity of the speaker module, and the connecting tube is stretchable, where

in a case that the first main body and the second main body rotate relative to each other to the folded state, the connecting tube is in the stretched state; and in a case that the first main body and the second main body rotate relative to each other to the unfolded state, the connecting tube is in a compressed state.

### BRIEF DESCRIPTION OF THE DRAWINGS

FIG. 1 is a schematic structural diagram of an electronic device when a first main body and a second main body move relative to each other to an unfolded state according to an embodiment of this disclosure.

FIG. 2 is a three-dimensional cross-sectional view of a partial structure of an electronic device when a first main body and a second main body move relative to each other to an unfolded state according to an embodiment of this disclosure.

FIG. 3 is a two-dimensional cross-sectional view of a partial structure of an electronic device when a first main body and a second main body move relative to each other to an unfolded state according to an embodiment of this disclosure.

FIG. 4 is a three-dimensional cross-sectional view of an electronic device when a first main body and a second main body move relative to each other to a folded state according to an embodiment of this disclosure.

FIG. 5 is a two-dimensional cross-sectional view of a partial structure of an electronic device when a first main body and a second main body move relative to each other to a folded state according to an embodiment of this disclosure.

FIG. 6 is a schematic structural diagram of a connecting tube in an electronic device according to an embodiment of this disclosure.

FIG. 7 is a schematic structural diagram of a double-shaft hinge structure in an electronic device according to an embodiment of this disclosure.

### DETAILED DESCRIPTION

The following clearly describes the technical solutions in the embodiments of this disclosure with reference to the accompanying drawings in the embodiments of this disclosure. Apparently, the described embodiments are some embodiments of this disclosure rather than all of the embodiments. All other embodiments obtained by a person of ordinary skill in the art based on the embodiments of this disclosure shall fall within the protection scope of this disclosure.

In the specification and claims of this disclosure, the terms “first” and “second” are used to distinguish similar objects, but are unnecessarily used to describe a specific sequence or order. It should be understood that the data in such a way are interchangeable in proper circumstances, so that the embodiments of this disclosure can be implemented in other orders than the order illustrated or described herein. Objects distinguished by “first”, “second”, and the like are usually one type, and the number of objects is not limited. For example, the first object may be one or more than one. In addition, in the specification and the claims, “and/or” means at least one of the connected objects, and the character “I” generally indicates an “or” relationship between the associated objects.

An electronic device provided in the embodiments of this disclosure is described below through specific embodiments and application scenarios thereof with reference to the accompanying drawings.

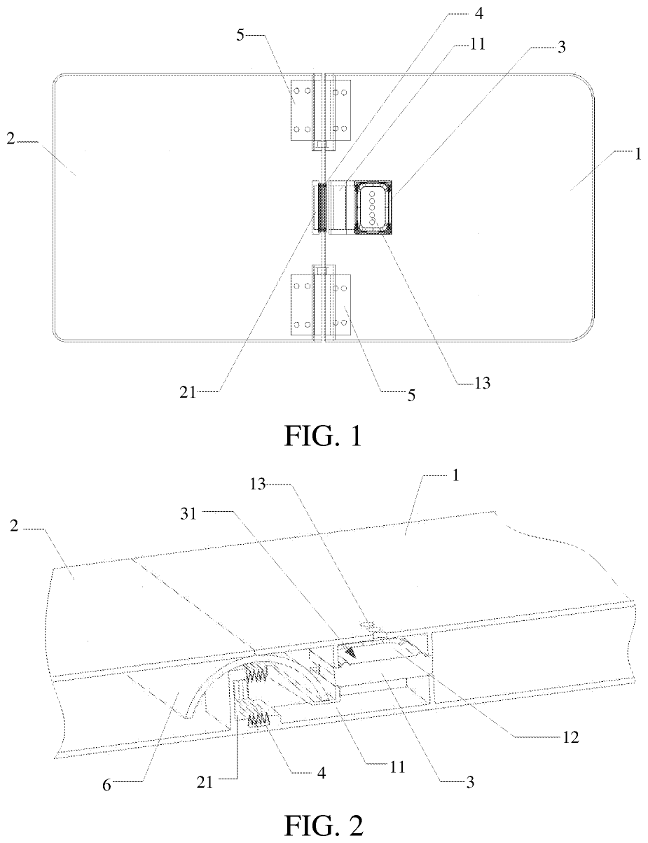

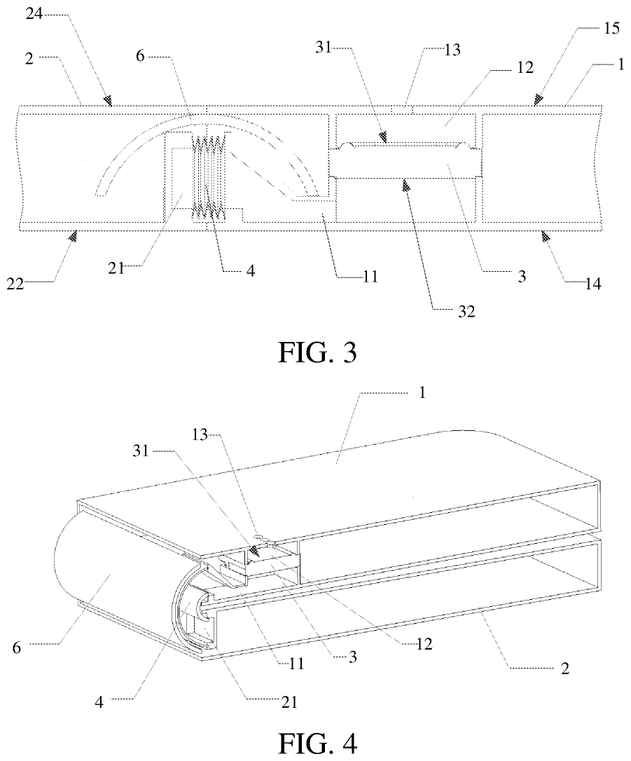

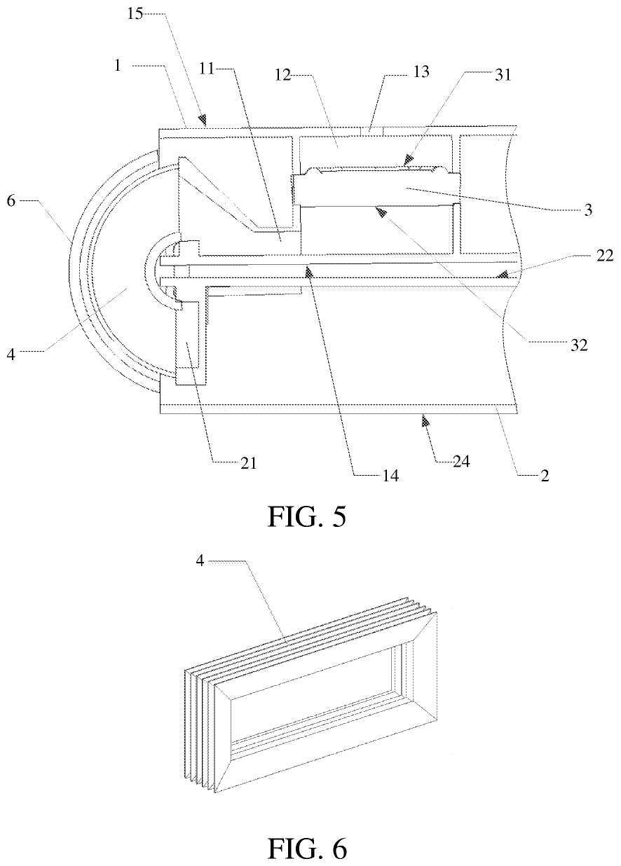

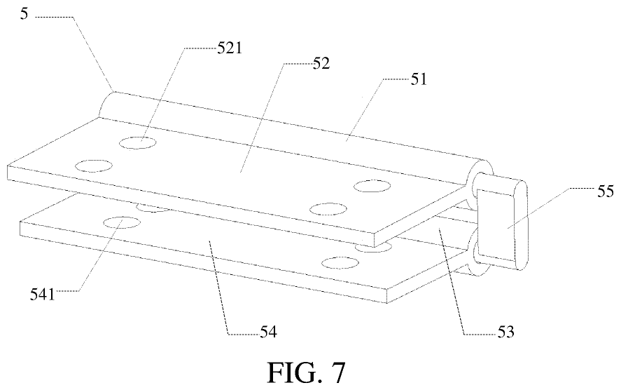

As shown in FIG. 1 to FIG. 7, the embodiments of this disclosure provide an electronic device, including: a first main body 1, a second main body 2, a speaker module 3 and a connecting tube 4, where

the first main body 1 and the second main body 2 are rotatable relative to each other to a folded state or an unfolded state;

the first main body 1 is provided with a first cavity 11 and the speaker module 3, and the first cavity 11 is in communication with the speaker module 3;

the second main body 2 is provided with a second cavity 21; and

the connecting tube 4 is disposed at a rotational joint between the first main body 1 and the second main body 2, two ends of the connecting tube 4 are respectively in communication with the first cavity 11 and the second cavity 21, the first cavity 11, the connecting tube 4, and the second cavity 21 together form a rear sound cavity of the speaker module 3, and the connecting tube 4 is stretchable, where

in a case that the first main body 1 and the second main body 2 rotate relative to each other to the folded state, the connecting tube 4 is in a stretched state; and in a case that the first main body 1 and the second main body 2 rotate relative to each other to the unfolded state, the connecting tube 4 is in a compressed state.

In the embodiments of this disclosure, the electronic device may include, but is not limited to: a mobile phone, a tablet personal computer, a laptop computer, a personal digital assistant (PDA), a mobile Internet device (MID), or a wearable device.

The first main body 1 may be a housing, or may be a display module, or may further be a composite structure of a housing and a display module; and The second main body 2 may be a housing, or may be a display module, or may further be a composite structure of a housing and a display module. Specifically, the first main body 1 and the second main body 2 may be rotationally connected by a rotating shaft, or may be rotationally connected by a hinge.

The connecting tube 4 may be various types of connecting tubes such as a plastic tube, a silicone tube, a rubber tube, or the like. When the connecting tube 4 is in the stretched state, the volume of the connecting tube 4 is increased, thereby increasing the volume of a rear sound cavity of the speaker module 3; and when the connecting tube 4 is in the compressed state, the volume of the connecting tube 4 is reduced, thereby reducing the volume of the rear sound cavity of the speaker module 3.

Specifically, that the two ends of the connecting tube 4 are respectively in communication with the first cavity 11 and the second cavity 21 may be that the two ends of the connecting tube 4 are respectively connected to and in communication with the first cavity 11 and the second cavity 21. In some embodiments, the two ends of the connecting tube 4 can be respectively sealed and connected to the first cavity 11 and the second cavity 21 through glue or a double-sided tape.

The first main body 1 may further be provided with a front sound cavity 12 and a sound outlet hole 13. The sound outlet hole 13 may be located on a surface of the first main body 1, and the front sound cavity 12 may be located between a sound outlet surface 31 of the speaker module 3 and the sound outlet hole 13. The front sound cavity 12 may be respectively in communication with the sound outlet surface 31 and the sound outlet hole 13, so that the sound produced from the sound outlet surface 31 is transmitted to the outside through the sound outlet hole 13. The sound outlet surface 31 of the speaker module 3 may refer to a surface of the speaker module 3 for producing a sound.

In the embodiments of this disclosure, since the first cavity, the connecting tube, and the second cavity together form a rear sound cavity of the speaker module, and the connecting tube is stretchable, in a case that the first main body and the second main body rotate relative to each other to the folded state, the connecting tube is in the stretched state, and in a case that the first main body and the second main body rotate relative to each other to the unfolded state, the connecting tube is in the compressed state, so that the voltage of the connecting tube can be changed with the change of a relative position of the first main body and the second main body, and then the voltage of the rear sound cavity of the speaker module can be changed with the change of the relative position of the first main body and the second main body. When the volume of the rear sound cavity is changed, the sound quality of the speaker module may also be changed. Therefore, in the embodiments of this disclosure, the sound quality of the speaker module can be changed with the change of the relative position of the first main body and the second main body, thereby further improving the audio playback effect of the speaker module of the electronic device.

Optionally, the first cavity 11 extends from the speaker module 3 to the connecting tube 4.

In the embodiments of this disclosure, specifically, that the first cavity 11 extends from the speaker module 3 to the connecting tube 4 may be that

the first cavity 11 extends from a non-sound outlet surface 32 of the speaker module 3 to the connecting tube 4. The non-sound outlet surface 32 of the speaker module 3 may refer to other surfaces of the speaker module 3 other than the sound outlet surface 31.

Optionally, the first main body 1 includes a first side close to the rotational joint, and the first cavity 11 is located on the first side; and

the second main body 2 includes a second side close to the rotational joint, and the second cavity 21 is located on the second side.

Since the first main body includes the first side close to the rotational joint, the first cavity is located on the first side, and the second main body includes the second side close to the rotational joint, and the second cavity is located on the second side, the communication between the connecting tube and the first cavity and the second cavity can be more convenient.

Optionally, in a case that the first main body 1 and the second main body 2 rotate relative to each other to the folded state, the first main body 1 includes a first surface 14 facing the second main body 2 and a second surface 15 facing away from the second main body 2, the second main body 2 includes a third surface 22 facing the first main body 1 and a fourth surface 24 facing away from the first main body 1, and the first surface 14 is opposite to the third surface 22;

the first cavity 11 is located between the first surface 14 and the second surface 15, the first cavity 11 is provided close to the first surface 14; and

the second cavity 21 is located between the third surface 22 and the fourth surface 24, the second cavity 21 is provided close to the third surface 22.

Since the first cavity is located between the first surface and the second surface, the first cavity is provided close to the first surface, and the second cavity is located between the third surface and the fourth surface, the second cavity is provided close to the third surface, the connection between the connecting tube and the first cavity and the second cavity is more convenient and the installation of the connecting tube is more convenient. In addition, a stretching process and a contracting process of the connecting tube can also be smoother.

Optionally, when the connecting tube 4 is in the stretched state, the connecting tube 4 is a straight tube; and when the connecting tube 4 is in the compressed state, the connecting tube 4 is an arc-shaped tube.

Since when the connecting tube is in the stretched state, the connecting tube is a straight tube; and when the connecting tube is in the compressed state, the connecting tube is an arc-shaped tube, the stretching process and the contracting process of the connecting tube can be smoother.

Optionally, a communication portion between the connecting tube 4 and the first cavity 11 is located in the first main body 1.

Since the communication portion between the connecting tube and the first cavity is located in the first main body, the communication portion between the connecting tube and the first cavity can be better protected, and the communication portion between the connecting tube and the first cavity can be prevented from being damaged by a foreign object.

Optionally, a communication portion between the connecting tube 4 and the second cavity 21 is located in the second main body 2.

Since the communication portion between the connecting tube and the second cavity is located in the second main body, the communication portion between the connecting tube and the second cavity can be better protected, and the communication portion between the connecting tube and the second cavity can be prevented from being damaged by a foreign object.

Optionally, the electronic device further includes a double-shaft hinge structure 5, where

the first main body 1 and the second main body 2 are connected by the double-shaft hinge structure 5.

Since the first main body and the second main body are connected by the double-shaft hinge structure, the connection between the first main body and the second main body can be more convenient, and a relative movement between the first main body and the second main body can be more convenient and smoother.

Optionally, the double-shaft hinge structure 5 includes a first rotating shaft 51, a first connection portion 52, a second rotating shaft 53, a second connection portion 54, and a third connection portion 55, where

the first rotating shaft 51 and the second rotating shaft 53 are spaced apart from each other and both are located on a first side of the third connection portion 55;

two opposite ends of the third connection portion 55 are respectively connected to the first rotating shaft 51 and the second rotating shaft 53;

the first connection portion 52 is respectively connected to the first rotating shaft 51 and the first main body 1; and

the second connection portion 54 is respectively connected to the second rotating shaft 53 and the second main body 2.

In the embodiments of this disclosure, the first connection portion 52 may be provided with a through hole 521 for connecting with the first main body 1. The second connection portion 54 may be provided with a through hole 541 for connecting with the second main body 2.

Since the first rotating shaft and the second rotating shaft are spaced apart from each other and both are located on the first side of the third connection portion, two opposite ends of the third connection portion are respectively connected to the first rotating shaft and the second rotating shaft, the first connection portion is respectively connected to the first rotating shaft and the first main body; and the second connection portion is respectively connected to the second rotating shaft and the second main body, the first main body and the second main body can rotate independently of each other, so that a relative movement between the first main body and the second main body can be more convenient and smoother.

Optionally, there are two double-shaft hinge structures 5, where the first main body 1 and the second main body 2 are connected by the two double-shaft hinge structures 5, the two double-shaft hinge structures 5 are spaced apart from each other, and the connecting tube 4 is located between the two double-shaft hinge structures 5.

In the embodiments of this disclosure, the two double-shaft hinge structures 5 may be respectively connected to the first main body 1 and the second main body 2.

Since the first main body and the second main body are connected by the two double-shaft hinge structures, the reliability of the connection between the first main body and the second main body is better. In addition, since the connecting tube is located between the two double-shaft hinge structures, the installation of the connecting tube can also be facilitated.

Optionally, the electronic device further includes a cover plate 6, where the cover plate 6 is disposed at the rotational joint, the cover plate 6, the first main body 1, and the second main body 2 enclose to form a third cavity, and the connecting tube 4 is located in the third cavity;

in a case that the first main body 1 and the second main body 2 rotate relative to each other to the folded state, at least a portion of the cover plate 6 is exposed; and in a case that the first main body 1 and the second main body 2 rotate relative to each other to the unfolded state, the first main body 1 and the second main body 2 jointly cover the cover plate.

In the embodiments of this disclosure, the cover plate 6 being at least partially exposed may mean that at least a portion of the cover plate 6 is exposed outside the first main body 1 and the second main body 2. In a width direction of the electronic device, the cover plate 6, the first main body 1, and the second main body 2 may or may not be aligned with each other. The double-shaft hinge structure 5 may further be located in the third cavity.

Since the electronic device further includes a cover plate, in a case that the first main body and the second main body rotate relative to each other to the folded state, at least a portion of the cover plate is exposed; and in a case that the first main body and the second main body rotate relative to each other to the unfolded state, the first main body and the second main body jointly cover the cover plate. Therefore, when the first main body and the second main body are folded, the cover plate can be exposed to protect an internal structure of the electronic device, for example, a connecting tube, or the like, and when the first main body and the second main body are unfolded, the cover plate can be hidden from the first main body and the second main body to reduce the effect of the cover plate on the normal use of the first main body and the second main body.

In the embodiments of this disclosure, the rear sound cavity of the speaker module of the electronic device is divided into two parts, which are respectively located in the first main body and the second main body, and are sealed and connected by a stretchable connecting tube, making full use of the change of folded space when a foldable electronic device is in different forms, which can increase the volume of the rear sound cavity of the speaker module without encroaching on internal layout space of the electronic device. That is, when the electronic device is folded, the connecting tube is stretched, and the volume of the rear sound cavity of the speaker module is increased, and when the electronic device is unfolded, the connecting tube is compressed, and the volume of the rear sound cavity of the speaker module is reduced, so that the sound quality of the speaker module can be changed with the change of the relative position of the first main body and the second main body, further improving the audio playback effect of the speaker module of the electronic device.

It should be noted that, the terms “include”, “comprise”, or any other variation thereof in this specification is intended to cover a non-exclusive inclusion, making a process, method, article or apparatus including a series of elements include not only those elements, but also other elements not expressly listed, or further elements inherent to such process, method, article or apparatus. Without more limitations, elements defined by the sentence “including one” does not exclude that there are still other same elements in the processes, methods, objects, or apparatuses.

The embodiments of this disclosure are described above with reference to the accompanying drawings. However, this disclosure is not limited to the foregoing specific implementations. The foregoing specific implementations are illustrative instead of limitative. Enlightened by this disclosure, a person of ordinary skill in the art may make many forms without departing from the idea of this disclosure and the scope of protection of the claims. All of the forms fall within the protection of this disclosure.

What is claimed is:

1. An electronic device, comprising: a first main body, a second main body, a speaker module, and a connecting tube, where
the first main body and the second main body are rotatable relative to each other to a folded state or an unfolded state;
the first main body is provided with a first cavity and the speaker module, and the first cavity is in communication with the speaker module;
the second main body is provided with a second cavity; and
the connecting tube is disposed at a rotational joint between the first main body and the second main body, two ends of the connecting tube are respectively in communication with the first cavity and the second cavity, the first cavity, the connecting tube, and the second cavity together form a rear sound cavity of the speaker module, and the connecting tube is stretchable, wherein
in a case that the first main body and the second main body rotate relative to each other to the folded state, the connecting tube is in a stretched state; and in a case that the first main body and the second main body rotate relative to each other to the unfolded state, the connecting tube is in a compressed state.

2. The electronic device according to claim 1, wherein the first main body comprises a first side close to the rotational joint, and the first cavity is located on the first side; and
the second main body comprises a second side close to the rotational joint, and the second cavity is located on the second side.

3. The electronic device according to claim 1, wherein in a case that the first main body and the second main body rotate relative to each other to the folded state, the first main body comprises a first surface facing the second main body and a second surface facing away from the second main body, the second main body comprises a third surface facing the first main body and a fourth surface facing away from the first main body, and the first surface is opposite to the third surface;
the first cavity is located between the first surface and the second surface, the first cavity is provided close to the first surface; and
the second cavity is located between the third surface and the fourth surface, the second cavity is provided close to the third surface.

4. The electronic device according to claim 1, wherein in a case that the connecting tube is in the stretched state, the connecting tube is a straight tube; and in a case that the connecting tube is in the compressed state, the connecting tube is an arc-shaped tube.

5. The electronic device according to claim 1, further comprising a cover plate, wherein the cover plate is disposed at the rotational joint, the cover plate, the first main body, and the second main body enclose to form a third cavity, and the connecting tube is located in the third cavity;
in a case that the first main body and the second main body rotate relative to each other to the folded state, at least a portion of the cover plate is exposed; and in a case that the first main body and the second main body rotate relative to each other to the unfolded state, the first main body and the second main body jointly cover the cover plate.

6. The electronic device according to claim 1, wherein a communication portion between the connecting tube and the first cavity is located in the first main body.

7. The electronic device according to claim 1, wherein a communication portion between the connecting tube and the second cavity is located in the second main body.

8. The electronic device according to claim 1, further comprising a double-shaft hinge structure, wherein
the first main body and the second main body are connected by the double-shaft hinge structure.

9. The electronic device according to claim 8, wherein the double-shaft hinge structure comprises:
a first rotating shaft, a first connection portion, a second rotating shaft, a second connection portion, and a third connection portion, wherein
the first rotating shaft and the second rotating shaft are spaced apart from each other and both are located on a first side of the third connection portion;
two opposite ends of the third connection portion are respectively connected to the first rotating shaft and the second rotating shaft;
the first connection portion is respectively connected to the first rotating shaft and the first main body; and
the second connection portion is respectively connected to the second rotating shaft and the second main body.

10. The electronic device according to claim 8, wherein there are two double-shaft hinge structures; and
the first main body and the second main body are connected by the two double-shaft hinge structures, the two double-shaft hinge structures are spaced apart from each other, and the connecting tube is located between the two double-shaft hinge structures.
